(19) United States
(12) Patent Application Publication
(10) Pub. No.: US 2007/0143662 A1
(43) Pub. Date: Jun. 21, 2007

(54) Inserting user interface elements into native applications

(75) Inventors: Andrew G. Carlson, Woodinville, WA (US); Brian T. Hill, Renton, WA (US); Peter Allenspach, Sammamish, WA (US); Rainer Schiller, Kirkland, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/303,203

(22) Filed: Dec. 15, 2005

(51) Int. Cl. G06F 17/00

(52) U.S. Cl. 715/507

(57) ABSTRACT

Custom user interfaces are inserted into native applications enabling various presentation formats to be used for integrating inserted user interfaces with existing user interface(s) of the native application. Inserted user interfaces may be presented as collapsible adjoining form regions, task panes, and/or large form regions as part of a tab collection of the native application. Registering the added user interfaces in a structured file in the operating system registry instead of an application protocol interface registration specific to the application enables synchronized installation of custom user interfaces and their controls.

### BACKGROUND

Many applications such as electronic mail, Internet browser, instant messaging, and the like, utilize multiple user interfaces serving different purposes in an integrated fashion. For example, an electronic mail application may include a user interface for composing messages, another user interface for reviewing received messages, and the like. A user interface including controls for the whole application may be used as an umbrella to integrate the different user interfaces.

Applications like those listed above utilize forms for presenting information to users and interacting with the users. A form represents the outermost grouping of controls within an application page. For example, an HTML form is a section of a Web page containing normal content, markup tags, special elements called controls (check boxes, radio buttons, menus, and so on), and labels on those controls. The form is a container that allows for a rich set of controls that cleanly encapsulate page logic into reusable components, and it allows for separation of code and content on a page.

While typical individual users of such applications may use the application without major modifications, institutional customers such as enterprises may desire to add custom capabilities to their applications. For example, adding voice messaging capability to an electronic mail application, modifying one or more of the controls, providing centralized database connections, and the like, may be some of the custom features that can be added to an application.

If a developer attempts to control an extended user interface at runtime, an add-in is typically required, but the add-in needs to be delivered in a different way from the way the form is delivered. Therefore, when updates are rolled out, the add-in and the form may not match on a user's machine for a period of time, leading to unpredictable behavior. Form developers may have to get their administrators to publish each version of their work. Running a setup application on the client machine is generally insufficient. Furthermore, runtime may be limited to one solution on a given item. There may not be a provision for multiple sets of additional user interfaces on the same form.

It is with respect to these and other considerations that the present invention has been made.

### SUMMARY

This summary is provided to introduce a selection of concepts in a simplified form that are further described below in the Detailed Description. This summary is not intended to identify key features or essential features of the claimed subject matter, nor is it intended as an aid in determining the scope of the claimed subject matter.

Aspects are directed to inserting custom user interfaces into native applications. Custom, form may be added to user interfaces of native applications as collapsible adjoining form regions, task panes, large form regions as part of a tab collection of the native application, or a combination of those.

Registering the added user interfaces in a structured file in the operating system registry instead of an application protocol interface registry specific to the application enables synchronized installation of custom user interfaces and their controls. Furthermore, content placement of custom user interfaces may be dynamically adjusted based on selection of form properties.

These and other features and advantages, which characterize aspects of the present disclosure, will be apparent from a reading of the following detailed description and a review of the associated drawings. It is to be understood that both the foregoing general description and the following detailed description are explanatory only and are not restrictive of aspects as claimed.

### BRIEF DESCRIPTION OF THE DRAWINGS

FIG. 1 is a block diagram of an exemplary computing operating environment;

FIG. 2 is an example network environment where a native application with inserted user interfaces may be implemented according to embodiments;

FIG. 3 illustrates an example screenshot of an electronic mail application with multiple adjoining form regions;

FIG. 4 illustrates an example user screenshot of the electronic mail interface of FIG. 3 with additional large form regions;

FIG. 5 illustrates an example screenshot of the electronic mail interface of FIG. 3 with additional task pane form regions;

FIG. 6 illustrates another example user interface of the electronic mail interface of FIG. 5 with a different presentation of an additional task pane form region;

FIG. 7 illustrates example contents of a structured file for registering inserted user interfaces; and

FIG. 8 illustrates a flowchart of a process for inserting additional user interfaces to a native application according to embodiments.

### DETAILED DESCRIPTION

As briefly described above, embodiments are directed to inserting custom user interfaces to a native application. In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

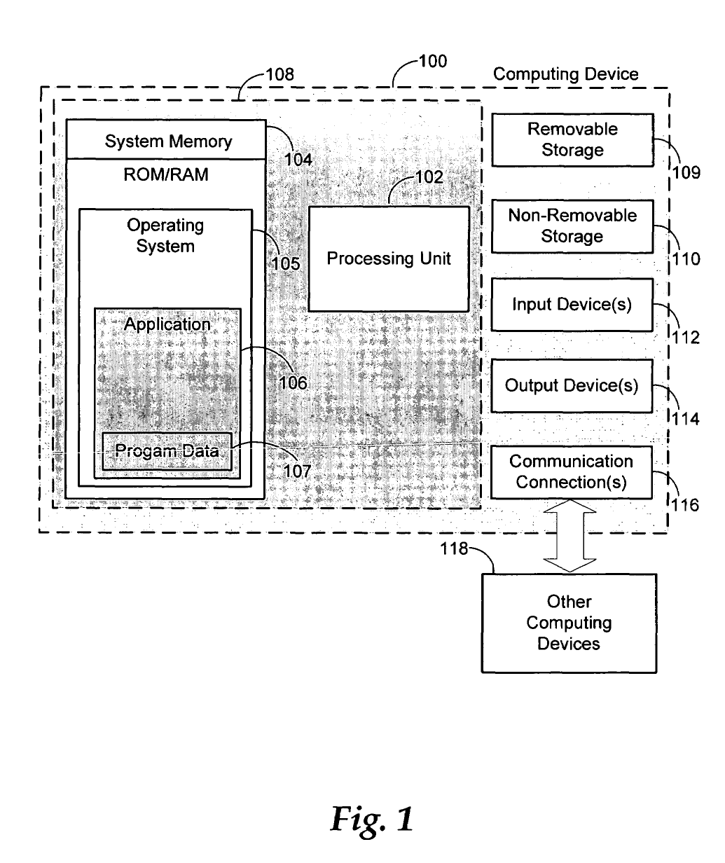

Referring now to the drawings, in which like numerals refer to like elements through the several figures, aspects and an exemplary computing operating environment will be described. FIG. 1 and the following discussion are intended to provide a brief, general description of a suitable computing environment in which the invention may be implemented. While the embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and the like. Embodiments may also be practiced in distributed computing environments where tasks are performed by remote processing devices that are linked through a communications network. In a distributed computing environment, program modules may be located in both local and remote memory storage devices.

Embodiments may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process.

With reference to FIG. 1, one exemplary system for implementing the embodiments includes a computing device, such as computing device 100. In a basic configuration, the computing device 100 typically includes at least one processing unit 102 and system memory 104. Depending on the exact configuration and type of computing device, the system memory 104 may be volatile (such as RAM), non-volatile (such as ROM, flash memory, etc.) or some combination of the two. System memory 104 typically includes an operating system 105 suitable for controlling the operation of a networked personal computer, such as the WINDOWS® operating systems from MICROSOFT CORPORATION of Redmond, Wash. The system memory 104 may also include one or more software applications such as application 106, and may include program data 107. This basic configuration is illustrated in FIG. 1 by those components within dashed line 108.

According to embodiments, the application 106 may comprise many types of programs, such as an electronic mail program, an instant messaging program, an Internet browsing program, an Internet telephony program, an video conferencing program, and the like. An example of such programs is OUTLOOK® manufactured by MICROSOFT CORPORATION. The application 106 may also comprise a multiple-functionality software application for providing many other types of functionalities. Such a multiple-functionality application may include a number of program modules, such as a word processing program, a spreadsheet program, a slide presentation program, a database program, and the like. An example of such a multiple-functionality application is OFFICE™ manufactured by MICROSOFT CORPORATION.

The computing device 100 may have additional features or functionality. For example, the computing device 100 may also include additional data storage devices (removable and/or non-removable) such as, for example, magnetic disks, optical disks, or tape. Such additional storage is illustrated in FIG. 1 by removable storage 109 and non-removable storage 110. Computer storage media may include volatile and nonvolatile, removable and non-removable media implemented in any method or technology for storage of information, such as computer readable instructions, data structures, program modules, or other data. System memory 104, removable storage 109 and non-removable storage 110 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 100. Any such computer storage media may be part of device 100. Computing device 100 may also have input device(s) 112 such as keyboard, mouse, pen, voice input device, touch input device, etc. Output device(s) 114 such as a display, speakers, printer, etc. may also be included. These devices are well known in the art and need not be discussed at length here.

The computing device 100 may also contain communication connections 116 that allow the device to communicate with other computing devices 118, such as over a network in a distributed computing environment, for example, an intranet or the Internet. Communication connection 116 is one example of communication media. Communication media may typically be embodied by computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

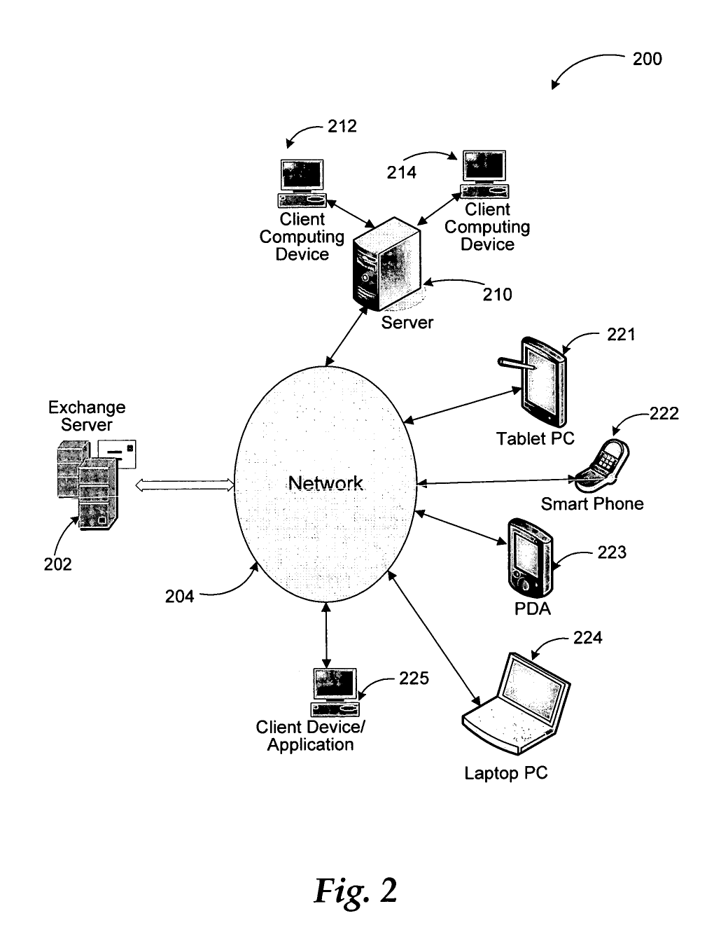

Referring to FIG. 2, an example network environment where a native application with custom user interfaces may be implemented is illustrated. As described above, embodiments are directed to inserting custom user interfaces into native applications, especially electronic communication applications such as electronic mail applications, instant messaging applications, browser applications, and the like. Such applications may be implemented on individual computing devices, but are typically used in networked environments where one or more administrators control aspects of the applications running on multiple client machines.

System 200 may comprise any topology of servers, clients, Internet service providers, and communication media. Also, system 200 may have a static or dynamic topology without departing from the spirit and scope of the present invention.

System 200 includes at least one exchange server 202, which provides services to other nodes of network 204 that may include client devices 221-225 directly connected to network 204 such as tablet PC 221, smart phone 222, PDA 223, laptop PC 224, and client device/application 225. Nodes of network 204 may further include client computing devices 212 and 214, which are connected to a subnet managed by server 210 and connect to network 204 through server 210. Services provided by exchange server 202 may depend on a type of exchange application and network 208. Exchange applications may include email applications, browsing applications, file transfer applications, audio streaming applications, video streaming applications, and other applications.

Exchange server 202 may manage an electronic mail application shared by a plurality of client computing devices. Depending on actions and modes of operation, the electronic mail operation may include a number of user interfaces. For example, a read mail screen, a compose mail screen, a folder list screen, and the like. Some enterprise level users may desire to add their own custom user interfaces to the electronic mail application. In typical applications, such a customization effort may include providing user interface specifications as well as any add-in modules associated with those user interfaces to each client device. Usually any custom user interfaces and add-in's are registered either at the user level, at a local form level, or folder level registry. This may present difficulty in keeping track of and maintaining all custom forms and their sources at the enterprise level.

According to one embodiment, registration of these “runtime” forms at local level such as Messaging Application Interface Protocol (MAPI) level is eliminated and the custom forms are registered in an operating system registry using a structured file such as an extensible Mark-up Language XML) file.

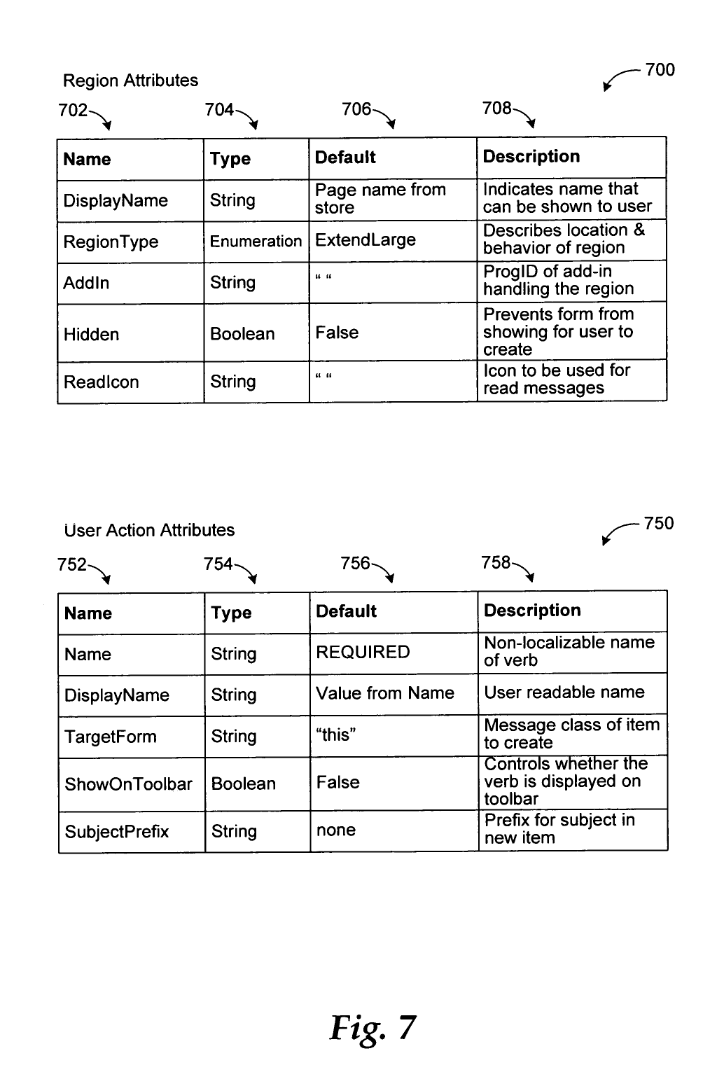

User interface elements of the custom form region(s) may be registered in the operating system registry by providing names and attributes of the user interface elements. Such user interface elements may include a user interface, an add-in, an icon, or an allowed action for a user. However, elements of a custom form user interface are not limited to these examples. Many other elements may also be registered along with their attributes. Further examples are illustrated in conjunction with FIG. 7 below.

Network 204 provides communication between the nodes described above. By way of example, and not limitation, network 204 may include wired media such as a wired network or direct-wired connection, and wireless media such as acoustic, RF, infrared and other wireless media.

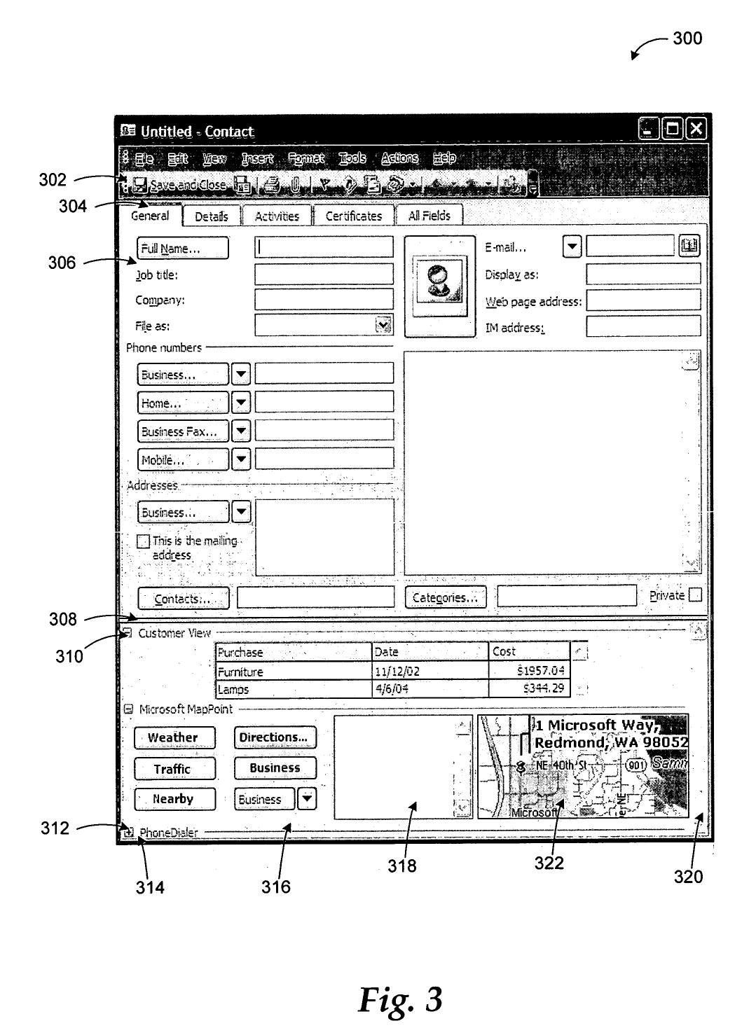

Now referring to FIG. 3, an example screenshot of an electronic mail application with multiple adjoining form regions is illustrated. Example screenshot 300 includes a menu bar and icon tray 302, which provide a user with selections for actions related to the electronic mail application. Form surface 306 of the electronic mail application includes one of five separate user interfaces in tab-organized style. The example shows the “General” tab (304) for “Contacts” portion of the application. Other portions of the application may include “Read Mail”, “Compose Mail”, “Calendar”, and the like. Form surface 306 for “General” tab includes typical data fields for an address book type application: name, address, phone numbers, email address, and the like.

As mentioned before, users may desire to include additional functionality in their applications. For example, a retail sales company may want to bring up customer history information along with the contact information. A service company may add map information for their personnel along with the contact's address. Because such desired functionalities may vary widely and it may be impossible to format the general form surface to accommodate any customization, it is advantageous to enable users to add their own custom forms.

According to some embodiments, the custom form region may include an adjoining form region, a separate tab-organized form region, or a task pane style form region. The adjoining form region type may be collapsible. In fact, a plurality of adjoining or separate form regions may be integrated into the native application user interface.

A type, a size, or a layout of the custom form region may be determined by one of: a user selection, content of the custom form region, or content of the native application user interface.

In some embodiments, a presentation of the custom form region may be limited to one of a plurality of user interfaces of the native application. For example, the collapsible adjoining form regions may only be shown when the first separate region tab of the native application is selected.

Once the custom form region is added, a menu bar, a menu ribbon, or a similar control section of the native application user interface may be dynamically modified based on the content of the custom form region. The request for the custom form region may simply be an insertion of a field into the native application user interface by a user. The custom form may then be generated based on the inserted field and associated data.

The lower portion of example screenshot 300 illustrates three adjoining custom form regions separated by splitter 308 from form surface 306 for the electronic mail application. While all three example form regions are collapsible, only one (collapsed region 314 “PhoneDialer”) is shown in collapsed format.

Region collapse controls 310 and 312 are examples of how form regions can be controlled for their format. The first adjoining form region “Customer View” includes sales history data for the particular contact. Bindings may be established between data fields and/or controls of the native application user interface and data fields and/or controls of the custom form region such that one is dynamically updated when the other is modified. In this case, the sales history data may be retrieved by the custom form based on the contact in formation on form surface 306.

Form surface 316 for the second custom form region includes address-related information such as click-on buttons for weather information, traffic information, directions, and the like. Form surface 316 further includes text box control 318 and bitmap control 322 (for providing a map of the associated address). An all section scrollbar may also be used to navigate through the custom form regions.

As mentioned above, a menu bar, a menu ribbon, or a similar control section of the native application user interface may be dynamically modified based on the content of the custom form region. For example, upon installation of the three example form regions, the menu bar of the electronic mail application may include items for modifying attributes of the map associated with the address, specifying a date range for the sales history data associated with the contact, and the like.

Moreover, adjoining custom form regions may be associated with one or more separate form regions of the application. In the example screenshot, the custom form regions are shown together with the “General” tab 304. In some embodiments, other custom form regions may be associated with other tabs such as “Details” or “Activities” tabs. In other embodiments, the custom forms may be presented independent of the native application separate forms, or they may be presented with one tab only.

In one embodiment, a content placement of a native application user interface or a custom form region user interface may be dynamically modified based on a user selection for the user interface. For example, such a user selection may include language for the user interface. Thus, allocated space for text, such as subject box in an electronic mail application, is dynamically adjusted for changing language preserving a look-and-feel of the user interface despite changing text length. A similar adjustment may be made for other data types such as images, and the like.

The language in example screenshot 300 is English. However, today many applications are multi-lingual; meaning the user can select another language as an option, and all user interface text is automatically translated without changing a general format of the form surface. Text length may not be similar in some languages. Accordingly, dynamically adjustable controls on the form surface enable preservation of the look-and-feel of the form surface while adjusting text box widths, and the like.

It should be noted that the terms form, form region, custom form region are just that, terms to identify items on an application user interface. Therefore, other terms such as sections, section controls, and the like, may be used for the same items without departing from a scope and spirit of the invention.

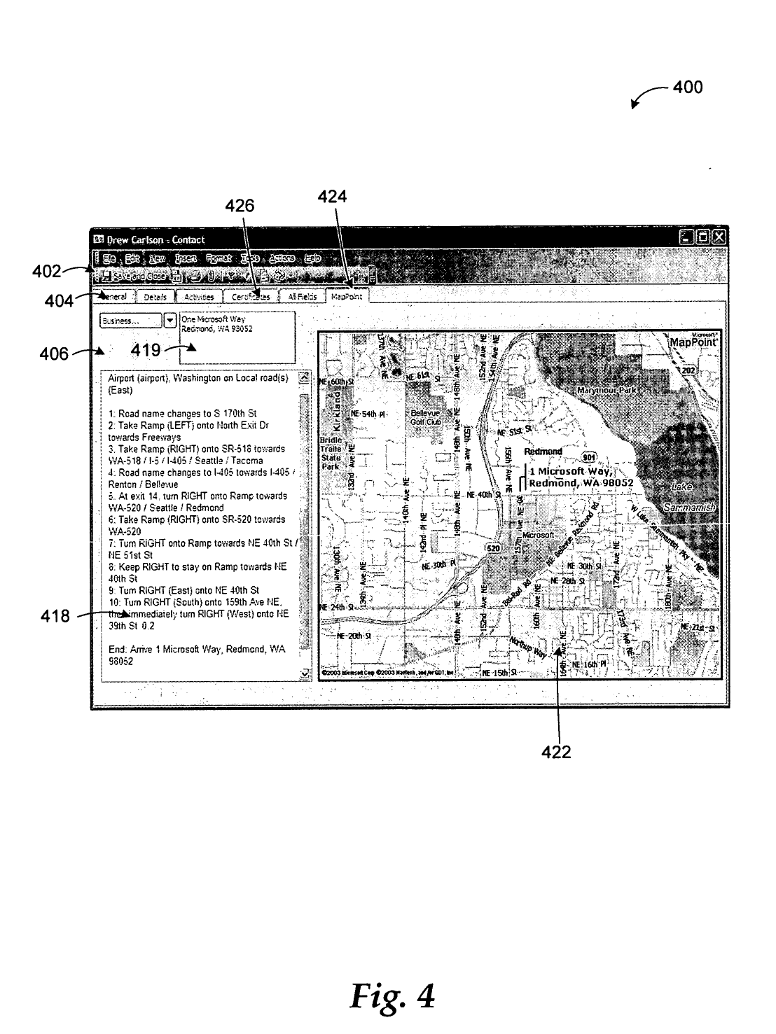

FIG. 4 illustrates an example screenshot of the electronic mail interface of FIG. 3 with additional large form regions. Elements of example screenshot 400 that are similarly numbered as elements of screenshot 300 of FIG. 3 have the same properties.

The shown screen of electronic mail application is “MapPoint” tab 424. Standard tabs of the native application such a “General” tab 404 and “Certificates” tab 426 remain unchanged. The custom form 406 is in separate form format in this case under “MapPoint” tab 424.

Custom form 406 includes an address selection button (set to “Business” on the screenshot), text box 419 for address, text box control 418 for directions, and bitmap control 422 for the map associated with the address. As described previously, some data fields or controls may be bound to data fields and/or controls on standard forms. In this example, text box control 418 for directions, and bitmap control 422 for the map are bound to an address data field on the Contacts form of the native application. Text box 419 is a copy of the address data field to show that binding the data fields and controls can result in a various functions ranging from copying the data to using the data for retrieving associated information.

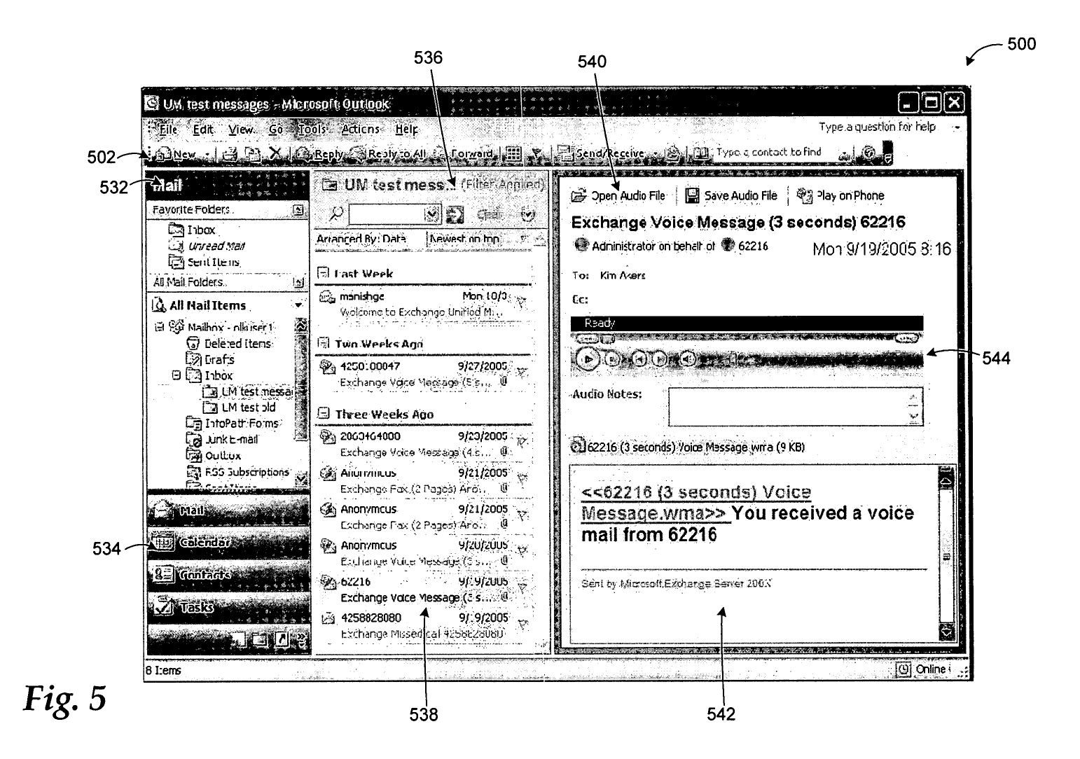

FIG. 5 illustrates an example user interface of the electronic mail interface of FIG. 3 with additional task pane form regions. User interface 500 includes menu bar and icon tray 502, mail folders pane 532, collapsed panes for other application tasks such as calendar 534, contacts, 535, and tasks 537, under the unfolded mail folder pane. In the center of the screenshot is a pane for received mail under one of the folders (UM test messages folder 536). The folder is also shown with highlight in the mail folders pane 532.

One of the received messages is highlighted (voice message 538). Custom form 542 in task pane format on the left side of the screenshot shows information associated with the highlighted voice message 538. At the top of form 542 are user actions and assigned icons (e.g. Open Audio File 540). Below the user actions is information regarding a source and duration of the voice message. This information is followed by destination and courtesy-copy information similar to an electronic mail presentation. In the middle of form 542 is an audio player user interface 544 to replay the message for the user. Below the audio player user interface 544 is a text box control similar to a body of an electronic mail message.

As the figure shows, custom form 542 is used to modify a standard electronic mail user interface and customize it for voice messages. Thus, custom form 542 may be shown to the user in a task pane interchangeably with the standard electronic mail user interface. Activation controls of custom form 542 may be set such that it is activated only when a voice message type electronic mail is selected in the center pane. If another type message is selected, the standard user interface may be activated.

By allowing user installation of custom form regions, security concerns due to forms installed by unknown sources at enterprise level are also addressed. Because the user interface and associated add-in(s) are installed synchronously under an administrator or user's control, the custom form can be trusted. According to another embodiment, the custom form region may be presented in a “read mail” user interface of the electronic mail application, which is typically restricted due to security concerns.

The invention is not limited to the examples shown above. Other types of implementations, for example custom forms for video messages, executable attachments, and the like may also be realized without departing from a scope and spirit of the invention.

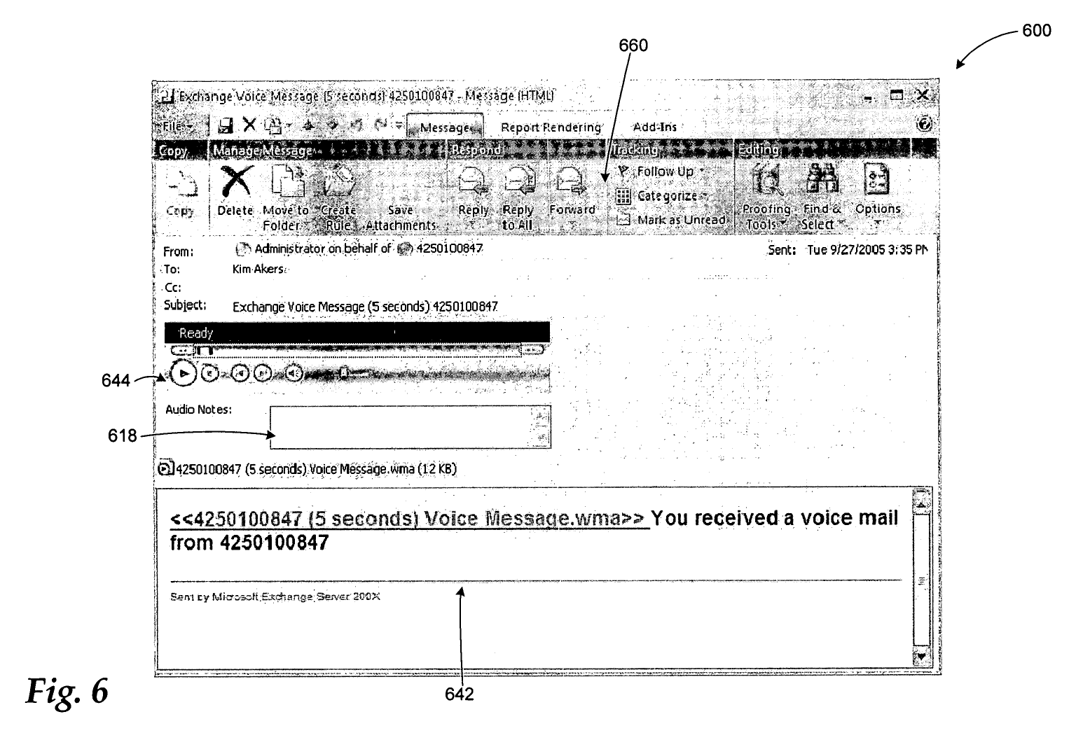

Referring to FIG. 6, another example user interface of the electronic mail interface of FIG. 5 is illustrated with a different presentation of an additional task pane form region.

Example user interface 600 includes a different type of management bar compared to the traditional menu bars and icon trays of the previous examples. Sometimes referred to as “ribbon”, this user interface combines features of icons with drop-down menus and listing of actions.

Differently from FIG. 5, the mail folders pane and received mail pane are not shown in this screen. The custom form 642 for replaying voice messages is depicted as the dominantly presented form. Audio player user interface 644 includes text box control 618 for audio notes. Information regarding source, destination, and courtesy-copy are shown above audio player user interface 644, along with a subject line that provides details about the type of message and duration.

As mentioned before, items in the management bar such as ribbon 660 may be dynamically modified to reflect custom functionality of custom form 642. For example, additional buttons or actions specific to replaying audio files may be added when custom form 642 is active.

FIG. 7 illustrates example contents of a structured file for registering inserted user interfaces. As described previously, some or all elements of the custom form user interfaces may be registered with the operating system registry.

Example table 700 shows five elements of region attributes. The attributes listed in first column 702 “Name” are: DisplayName, RegionType, Addin, Hidden, and ReadIcon. Types of each element are defined in second column 704 “Type.” A default value for each element is listed in third column 706 “Default.” Finally the elements are described in fourth column 708 “Description.”

According to the example table, DisplayName is the name of the form shown to the user, and is retrieved from a data store. RegionType defined a location and behavior of the form (e.g., adjoining form associated with first tab, placed at the bottom of the tab, and the like).

AddIn is the variable defining a program ID of an add-in module that handles the form region. Hidden is an attribute that, when set to true, prevents the form from being shown such that a user can create it. Finally, ReadIcon is an example of an icon that can be registered to indicate read messages.

Example table 750 shows five elements of user action attributes. As explained before, allowed user actions may also be registered for each form. Columns, 752, 754, 756, and 758 are the same as in table 700. First example user action attribute is Name, which is a non-localizable name of verb (action). DisplayName indicates the user readable name similar to the variable under region attributes.

TargetForm defines a message class of the item to be created. ShowOnToolbar controls whether or not the action is to be included on the toolbar. Subject Prefix indicates a prefix for subject in the new item (e.g. “FW” for forwarded email, “RE” for replied email, etc.).

Embodiments are not limited to the elements and attributes described above, however. Many other elements and attributes for custom form regions may be registered. Furthermore, embodiments are not limited to electronic mail applications only. Addition of custom form regions may be implemented in other applications such as instant messaging, browsing applications, and the like, using the principles described herein.

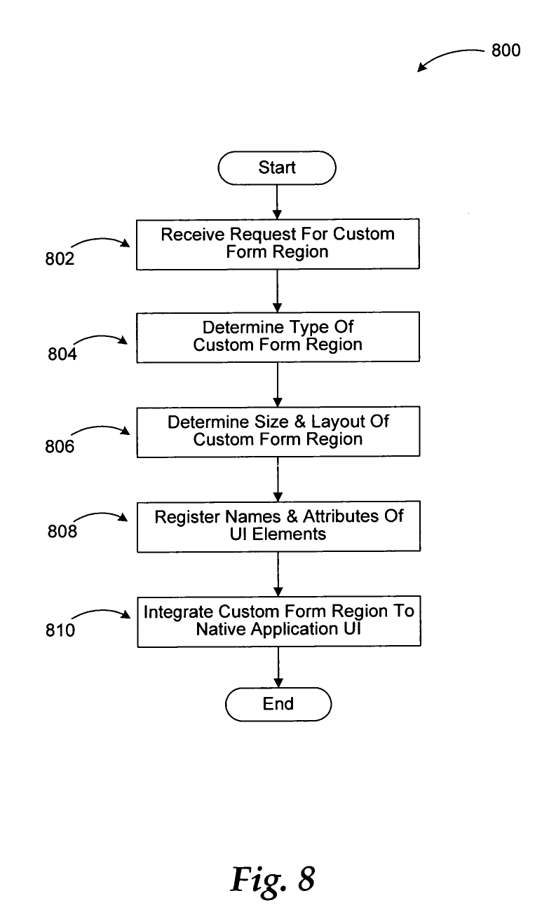

FIG. 8 illustrates a flowchart of a process for inserting additional user interfaces to a native application according to embodiments. Process 800 may be implemented in an application like an electronic mail program, an instant messaging program, an Internet browsing program, and the like.

Process 800 begins with operation 802, where request for a custom form region is received. Operation 802 is followed by operation 804, where a type of the custom form region is determined. The custom form region may be an adjoining custom form region, a separate tab-organized style custom form region, or a task pane style custom form region. The form region may include one or more forms. Moreover, the one or more forms may be various combinations of the above listed types.

The type of the custom form region may be determined based on a user selection or a dynamic decision process that is responsive to content of the custom forms and/or existing user interface forms of the native application. Processing advances from operation 804 to operation 806.

At operation 806, a size and layout of the custom form(s) are determined. The size and layout may also be determined based on content of the custom form(s), as well as content, size, and layout of the native application user interface. Processing moves from operation 806 to operation 808.

At operation 808, elements of the custom form user interfaces are registered with a operating system registry using a structured file. Names and attributes of the elements are reported to the registry including, user interfaces, add-in's, icons, allowed user actions, and the like. Processing proceeds from operation 808 to operation 810.

At operation 810, the custom form region is integrated into the native application. The integration may include binding of select data fields and controls between the existing forms and the custom form(s) such that modification to one results in dynamic update of the other. After operation 810, processing moves to a calling process for further actions.

The operations included in process 800 are for illustration purposes. Inserting user interfaces into a native application may be implemented by a similar process with fewer or additional steps, as well as in different order of operations.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A computer-implemented method for inserting a group of user interface elements into a native application, comprising:
receiving a request for at least one custom form region that includes the group of user interface elements;
determining a type of the at least one custom form region;
registering the group of user interface elements in an operating system registry; and
integrating the at least one custom form region into the native application based on the determined type.

2. The computer-implemented method of claim 1, whereby the type of the at least one custom form region includes one of: an adjoining form region, a separate tab-organized form region, and a task pane style form region.

3. The computer-implemented method of claim 2, whereby the adjoining form region type is collapsible.

4. The computer-implemented method of claim 2, whereby the type of the custom form region is determined by one of: a user selection and a dynamic decision process based on content of the custom form region.

5. The computer-implemented method of claim 2, whereby at least one of a size and a layout of the custom form region are determined by one of: a user selection and a dynamic decision process based on content of the custom form region.

6. The computer-implemented method of claim 2, whereby a presentation of the custom form region is limited to one of a plurality of user interfaces of the native application.

7. The computer-implemented method of claim 1, whereby registering the group of user interface elements includes providing names and attributes of the group of user interface elements to the operating system registry in a structured file.

8. The computer-implemented method of claim 7, whereby the structured file is an extensible Mark-up Language (XML) file.

9. The computer-implemented method of claim 7, whereby the group of user interface elements includes at least one of: a user interface, an add-in, an icon, and an allowed action for a user.

10. The computer-implemented method of claim 1, further comprising:
dynamically modifying one of: a menu bar and a menu ribbon of a native application user interface based on content of the custom form region.

11. The computer-implemented method of claim 1, further comprising:
dynamically modifying a content placement of at least one of a native application user interface and a custom form region user interface based on a user selection for the user interface.

12. The computer-implemented method of claim 11, whereby the user selection for the user interface is a language selection.

13. The computer-implemented method of claim 1, further comprising:
binding at least one of a data field and a control of a native application user interface to at least one of a data field and a control of the custom form region.

14. The computer-implemented method of claim 1, wherein the request for the custom form region includes insertion of a field into a native application user interface by a user.

15. The computer-implemented method of claim 1, wherein the native application includes at least one of: an electronic mail application, an instant messaging application, a video messaging application, and a browser application.

16. A computer-readable medium having computer instructions for inserting a custom form region into a native application user interface, the instructions comprising:
receiving a request for the custom form region that includes at least one of: a user interface, an add-in, an icon, and an allowed action for a user;
determining a type, a size, and a layout of the custom form region;
registering elements of the custom form region in an operating system registry;
binding at least one of a data field and a control of the native application user interface to at least one of a data field and a control of the custom form region; and
integrating the custom form region into the native application user interface based on the determined type.

17. The computer-readable medium of claim 16, whereby at least one of: the type, the size, and the layout of the custom form region are determined by one of: a user selection, content of the custom form region, and content of the native application user interface.

18. A computer-implemented method for inserting a custom form region into an electronic mail application user interface, comprising:
receiving a request for the custom form region, whereby elements of the custom form region include at least one of: a user interface, an add-in, an icon, and an allowed action for a user;
determining a type of the custom form region based on a user selection;
determining a size and a layout of the custom form region based on at least one of: content of the custom form region and a size, a layout and content of the electronic mail application user interface;
registering the elements of the custom form region in an operating system registry;
binding at least one data field and at least one control of the electronic mail application user interface to at least one data field and at least one control of the custom form region; and
integrating the custom form region into the electronic mail application user interface based on the determined type.

19. The computer-implemented method of claim 18, whereby the type of the custom form region includes one of: an adjoining form region, a separate tab-organized form region, and a task pane style form region.

20. The computer-implemented method of claim 18, further comprising:
enabling the custom form region to be presented in a read mail user interface of the electronic mail application.
